(19) United States
(12) Patent Application Publication
(10) Pub. No.: US 2015/0236532 A1
(43) Pub. Date: Aug. 20, 2015

(54) CHARGING DEVICE FOR BATTERY PACK FOR POWER TOOL

(71) Applicant: MAKITA CORPORATION, Anjo-shi (JP)

(72) Inventor: Takuya UMEMURA, Anjo-shi (JP)

(21) Appl. No.: 14/614,870

(22) Filed: Feb. 5, 2015

(30) Foreign Application Priority Data
Feb. 14, 2014 (JP) 2014-026568

(51) Int. Cl. H02J 7/00

(52) U.S. Cl. CPC H02J 7/0013; H02J 7/0042; H02J 7/0052

(57) ABSTRACT

A charging device for a battery pack for a power tool comprises; a holder comprising a plurality of charging-ports where a battery pack for a power tool can be detachably fixed, wherein a secondary battery that can be charged and discharged and an information output section that can output information related to the secondary battery are integrated in the battery pack; a fuel cell that generates electric power by oxidation reaction of fuel and an oxidant; an information obtaining section to obtain information related to a battery pack fixed to the holder from the information output section; and, a controlling unit that controls charging power for one or more battery packs fixed to the holder based on information obtained in the information obtaining section.

### CROSS-REFERENCE TO RELATED APPLICATIONS

This application claims the benefit of Japanese Patent Application No. 2014-26568 filed Feb. 14, 2014 in the Japan Patent Office, the disclosure of which is incorporated herein by reference.

### BACKGROUND

The present invention relates to a charging device for battery pack for a power tool.

For example, WO2011/162357 describes a charging device for a power tool that comprises a fuel cell as a power supply. This charging device can charge a plurality of secondary batteries.

### SUMMARY

In one aspect of the present invention, it is favorable to efficiently charge a plurality of secondary batteries (battery packs) in a charging device for a power tool that comprises a fuel cell as a power supply.

One aspect of the present invention is a charging device for a battery pack for a power tool; a secondary battery that can be charged and discharged and an information output section that can output information related to the secondary battery are integrated in the battery pack. This charging device comprises, a holder comprising a plurality of charging-ports where the battery pack can be detachably fixed; a fuel cell that generates electric power by oxidation reaction of fuel and an oxidant; an information obtaining section to obtain information about the battery pack fixed to the holder from the information output section; and a controlling unit that controls charging power for one or more battery packs fixed to the holder based on the information obtained in the information obtaining section.

In one aspect of the present invention, since the charging power for one or more battery packs fixed to the holder is controlled based on the information about each secondary battery obtained in the information obtaining section, it is possible to suitably charge each secondary battery. Thus, it can be possible to efficiently charge a plurality of secondary batteries.

### BRIEF DESCRIPTION OF THE DRAWINGS

Hereinafter, a charging device for a power tool according to the embodiments of the present invention is explained with reference to the drawings in which;

FIG. 1 is a block diagram of a charging device according to the First Embodiment of the present invention;

FIG. 2 is an outside view of the charging device according to the First Embodiment of the present invention;

FIG. 3 is a flow chart illustrating charging control of the charging device according to the First Embodiment of the present invention;

FIGS. 4A and 4B are flow charts illustrating charging control of a charging device according to the Second Embodiment of the present invention;

FIG. 5 is a flow chart illustrating charging control of a charging device according to the Third Embodiment of the present invention;

FIGS. 6A and 6B are flow charts illustrating charging control of a charging device according to the Fourth Embodiment of the present invention;

FIG. 7 is a flow chart illustrating determinations of charging power by using identifying information; and

FIG. 8 is a flow chart illustrating determinations of charging power by using status information; and,

FIGS. 9A and 9B are flow charts illustrating charging control of a charging device according to the Fifth Embodiment of the present invention.

### DETAILED DESCRIPTION OF THE PREFERRED EMBODIMENTS

Power tools according to the embodiments of the invention of the present application are used in various fields, such as in metal processing, wood processing, stone processing, or for gardening. More specifically, the power tools may be an electric drill, electric driver, electric wrench, electric grinder, electric disc saw, electric reciprocating saw, electric jig saw, electric hammer, electric cutter, electric chain saw, electric planer, electric nail gun (including rivet gun), electric hedge trimmer, electric grass trimmer, electric lawn mower, electric weed wacker, electric blower, or electric cleaner.

### First Embodiment

1. Configuration of Charging Device

1.1 Outline

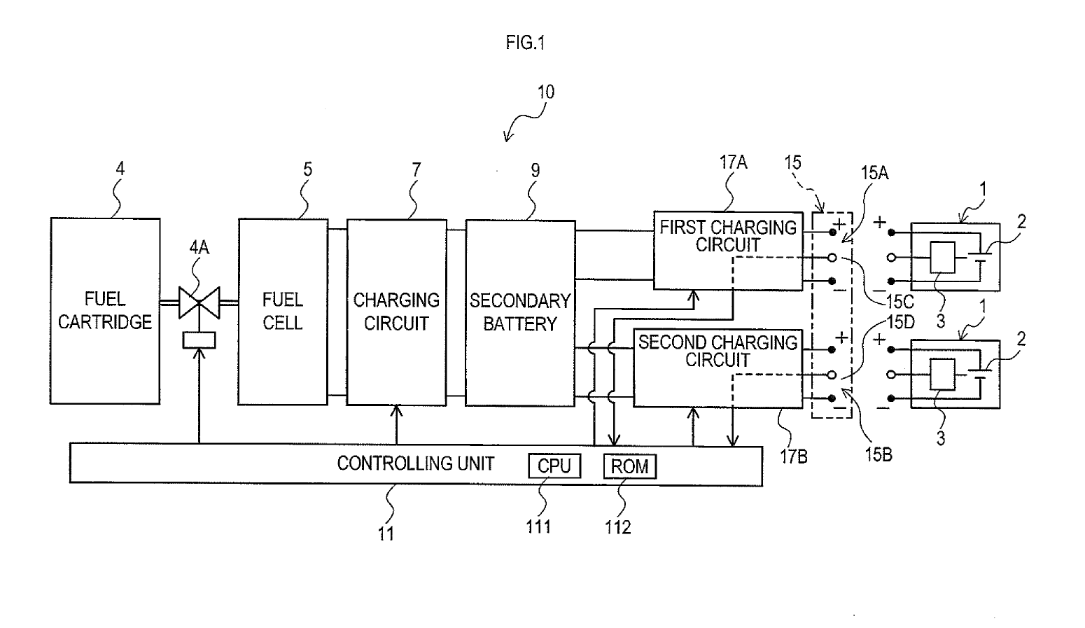

A charging device 10 illustrated in FIG. 1 is for charging a battery pack 1 for a power tool. The battery pack 1 comprises a secondary battery 2 that can be charged and discharged, an information output section 3 and so forth, and is an integrated package of the secondary battery 2, the information output section 3 and so forth. The secondary battery 2 according to the present embodiment is a lithium-ion battery.

The information output section 3 can output information related to the secondary battery 2. The information output section 3 according to the present embodiment is a part of a battery controlling unit (unillustrated). The battery controlling unit that comprises the information output section 3 is configured with a microcomputer comprising a CPU, an ROM, an RAM and so forth.

Output signals are inputted to the battery controlling unit from sensors, such as an electric-voltage sensor (unillustrated) for detecting voltage of the secondary battery 2 and a temperature sensor (unillustrated) for detecting temperature of the secondary battery 2, to detect status of the secondary battery 2.

The battery controlling unit monitors items to be monitored such as voltage, temperature, remaining energy, and deterioration status of the secondary battery 2 and whether the secondary battery 2 is overcharged, and outputs monitoring results of these items to be monitored to the charging device 10 from the information output section 3.

The battery controlling unit decides deterioration status of the secondary battery 2 based on accumulated number of charge times, types of the secondary battery 2 and so forth. The battery controlling unit decides the remaining energy of the secondary battery 2 and whether the secondary battery 2 is overcharged based on the voltage of the secondary battery 2. A program to execute the above decisions, etc. and information such as the types of the secondary battery 2, etc. are stored in a non-volatile memory unit such as an ROM in advance.

When the battery pack 1 is mounted to the charging device 10, information indicating monitoring results of each item to be monitored is sent and received between the charging device 10 and the battery controlling unit (the information output section 3). The basic functions of the charging device 10 are the following two functions.

(a) When the charging device 10 receives information that the secondary battery 2 is not fully charged, the charging device 10 supplies electric power to the secondary battery 2 of the battery pack 1 and starts charging. (b) When the charging device 10 receives information that the secondary battery 2 is overcharged, the charging device 10 stops supplying electric power to the secondary battery 2 of the battery pack 1.

1.2 Configuration of Charging Device

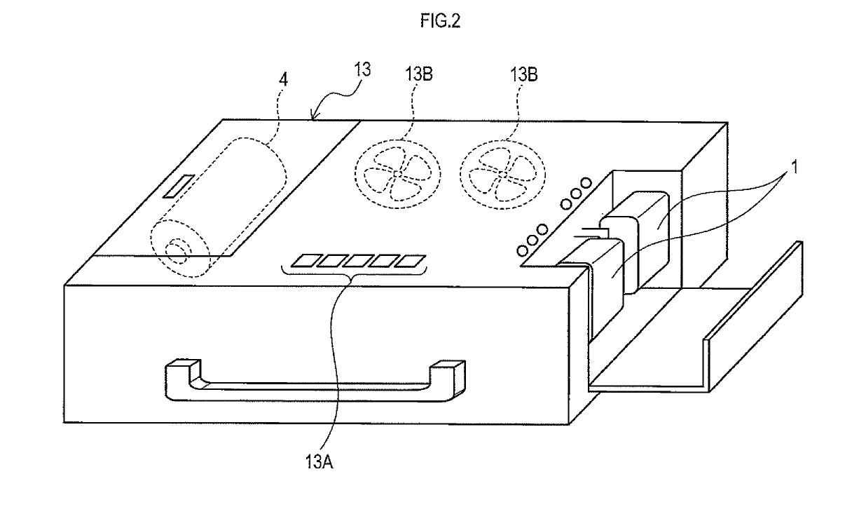

As illustrated in FIG. 1, the charging device 10 comprises a fuel cartridge 4, a fuel cell 5, a charging circuit 7, a secondary battery 9, a controlling unit 11, and a holder 15, etc. Components such as the fuel cartridge 4 are contained inside a casing 13 illustrated in FIG. 2. The fuel cartridge 4 is filled with fuel to be supplied to the fuel cell 5.

The fuel cartridge 4 is detachabley fixed to the casing 13 as illustrated in FIG. 2. If the fuel filling the fuel cartridge 4 is depleted, the fuel cartridge is not refilled with fuel; the fuel cartridge 4 is replaced with a new fuel cartridge 4.

The casing 13 comprises an inlet vent 13A to intake air. The air taken from the inlet vent 13A is supplied to the fuel cell 5 as an oxidant and is also sent to the fuel cell 5, the secondary battery 9 and so forth as cooling air. The air is then discharged to the outside by a fan 13B after cooling the fuel cell 5 and so forth.

The holder 15 is a part where the battery pack 1 is connected and comprises a plurality of charging-ports 15A, 15B, etc., where the battery pack 1 is detachably fixed as illustrated in FIG. 1. The charging-ports 15A and 15B respectively comprise signal ports 15C and 15D to send and receive information to and from the information output section 3.

The first charging circuit 17A supplies electric power for charge to a charging-port 15A (hereinafter referred to as first charging-port 1 5A). The second charging circuit 17B supplies electric power for charge to a charging-port 15B (hereinafter referred to as second charging-port 15B).

The first charging circuit 17A and the second charging circuit 17B supply electric power generated in the fuel cell 5 to the first charging-port 15A and the second charging-port 15B via the secondary battery 9. The fuel cell 5 generates electric power by oxidation reaction of fuel and an oxidant.

The fuel cell 5 according to the present embodiment is a direct methanol fuel cell (DMFC) that directly supplies not reformed fuel (hydrogen) but liquid fuel (methanol) stocked in the fuel cartridge 4. There is no pump or so forth disposed to send out fuel to the fuel cell 5 in the present embodiment; the fuel is supplied by using differential pressure between pressure inside the fuel cartridge 4 and pressure inside the fuel cell 5.

The secondary battery 9 is a chemical battery that can be charged and discharged. A lithium-ion battery is used as the secondary battery 9 in the present embodiment. The charging circuit 7 is a circuit to control an input electric power to the secondary battery 9 from the fuel cell 5. An electromagnetic valve 4A is a valve to adjust amount of fuel supplied to the fuel cell 5 from the fuel cartridge 4.

The controlling unit 11 controls operation of the electromagnetic valve 4A, the charging circuit 7, the first charging circuit 17A, and the second charging circuit 17B. In other words, the controlling unit 11 controls output electric power from the fuel cell 5 by controlling operation of the electromagnetic valve 4A and the charging circuit 7.

The controlling unit 11 uses information about the secondary battery 2 obtained via the signal port 15C to control the first charging circuit 17A. The controlling unit 11 uses information about the secondary battery 2 obtained via the signal port 15D to control the second charging circuit 17B likewise. In other words, the controlling unit 11 functions as an information obtaining section to obtain information about the battery pack 1 (hereinafter referred to as battery information) from the information output section 3 via the signal ports 15C and 15D.

The controlling unit 11 is configured with a microcomputer comprising a CPU, an ROM, an RAM and such. A program and so forth to control operation of the first charging circuit 17A, the second charging circuit 17B, etc. are stored in a non-volatile memory unit such as a ROM 112 in advance. A CPU 111 reads the program and so forth stored in the ROM 112 and such to execute control of the first charging circuit 17A, the second charging circuit 17B, etc.

2. Charge Control

2.1 Outline of Charge Control

The controlling unit 11 controls charging power for one or more battery packs 1 fixed to the holder 15 based on the battery information.

That is to say, the controlling unit 11 according to the present embodiment obtains information about electric power at the time of charging the secondary battery 2 (hereinafter referred to as allowable-charging-power information) as the battery information and controls the charging power for one or more battery packs 1 fixed to the holder 15 based on the obtained allowable-charging-power information and information about the electric power that the fuel cell 5 can output (hereinafter referred to as maximum output power).

More specifically, if the number of the battery packs 1 fixed to the holder 15 is one, the controlling unit 11 sets the charging power to electric power that corresponds to the allowable-charging-power information obtained from the information output section 3 of the battery pack 1 and executes a first charging-mode in which the charging power is outputted from the first charging circuit 17A or the second charging circuit 17B.

If the allowable charging power is larger than the maximum output power, the controlling unit 11 sets the charging power to the maximum output power and executes the first charging-mode. The allowable charging power is required electric power to charge the secondary battery 2, and also is the electric power at the value decided in the battery controlling unit as necessary.

Thus, a value of the allowable charging power (hereinafter also referred to as necessary charging power) is not fixed but vary according to information indicating status of the secondary battery 2 (hereinafter also referred to as status information) such as degradation status (e.g., the number of charge times) and temperature of the secondary battery 2. In other words, the battery controlling unit changes the necessary charging power (allowable charging power) into a smaller value when the degradation of the secondary battery 2 progresses and the temperature of the secondary battery 2 increases.

If the number of the the battery packs 1 fixed to the holder 15 is more than two (two, in the present embodiment), the controlling unit 11 executes a second charging-mode, in which each battery pack 1 is charged at the value obtained by dividing the maximum output power by the number of the battery packs 1 fixed to the holder 15 (two, in the present embodiment).

2.2 Detail of Charge Control

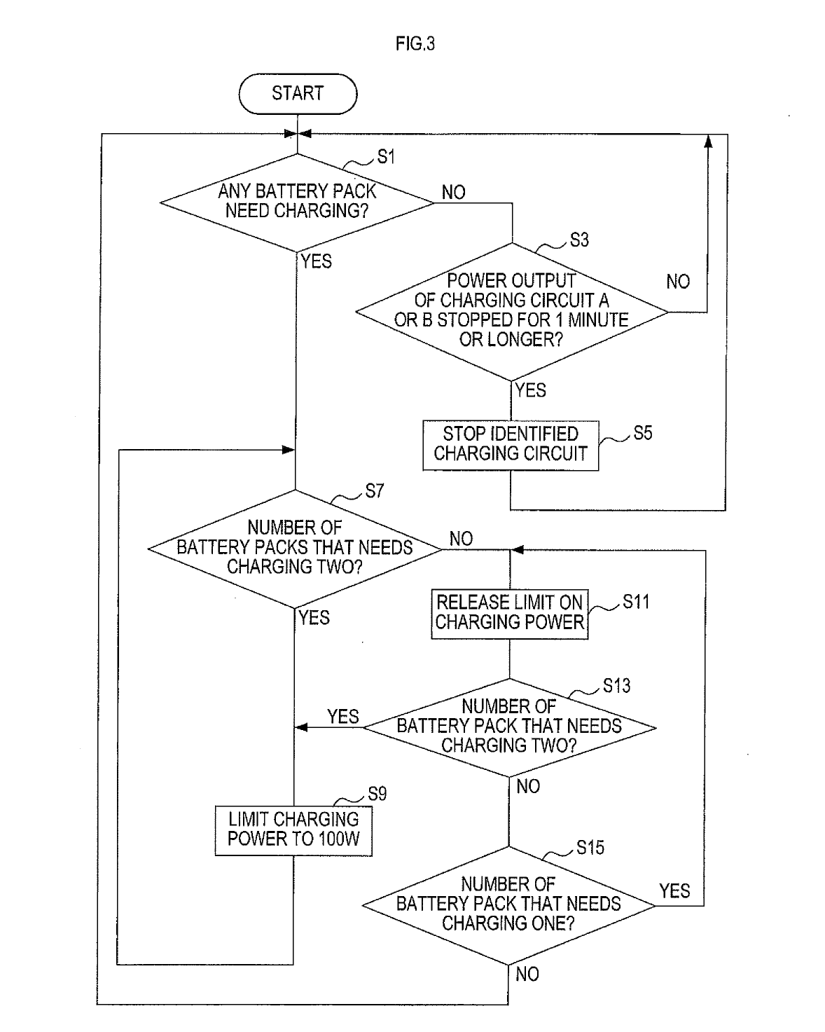

FIG. 3 is a flowchart indicating a charge control according to the present embodiment, and is illustrating an example case in which the maximum output power of the fuel cell 5 is 200 W and the necessary charging power for the battery pack 1 is 200 W or smaller.

A program to execute a control (hereinafter referred to as charge control) flow illustrated in FIG. 3 is stored in the aforementioned non-volatile memory unit in advance, and is read by the CPU 111 and activated when an activation switch (unillustrated) of the charging device 10 is turned on. When the activation switch is turned off, execution of the program stops at that point.

When the charge control program is activated, it is decided based on the battery information whether a battery pack 1 that needs charging is coupled to either the first charging-port 15A or the second charging-port 15B (S1). The battery pack 1 that needs charging includes an uncharged battery pack 1, that is, a brand-new battery pack 1.

If it is decided that the battery pack 1 that needs charging is not coupled to neither the first charging-port 15A nor the second charging-port 15B (S1: NO), it is decided whether either of the first charging circuit 17A or the second charging circuit 17B is continuously in the state of outputting no charging power for a given time (for example, one minute) or longer (S3).

If it is decided that either the first charging circuit 17A or the second charging circuit 17B is continuously in the state of outputting no charging power for the given time or longer (S3: YES), step S1 is executed after the identified charging circuit is put into a stopped state (S5). If it is decided that the state of outputting no charging power has not continued for the given time or longer (S3: NO), step S1 is executed without stopping the charging circuit.

If it is decided that the battery pack 1 that needs charging is coupled to either the first charging-port 15A or the second charging-port 15B (S1: YES), it is decided whether the number of battery packs 1 that needs charging is two (S7).

If it is decided that the number of battery packs 1 that needs charging is two (S7: YES), the charging power is set to a value (100 W) obtained by deviding the maximum output power of the fuel cell 5 (200 W) by the number of fixed battery packs 1 (two, in the present embodiment) and the second charging-mode to charge each battery pack 1 is executed (S9).

If it is decided that a number of the battery packs I that needs charging is not two, in other words, a number of the battery pack 1 that needs charging is one (S7: NO); the limit to set the charging power of each charging-port 15A and 15B at 100 W (the second charging-mode) is released (S11).

Because the charging device 10 according to the present embodiment operates in either the first charging-mode or the second charging-mode, if the second charging-mode is deactivated (S11), the charging-mode is automatically switched to the first charging-mode. If the first charging-mode is deactivated (S9), the charging-mode is automatically switched to the second charging-mode likewise.

If the second charging-mode is deactivated (S11), it is decided whether the number of battery packs 1 that needs charging is two (S13). If it is decided that the number of battery packs 1 that needs charging is two (S13: YES), the second charging-mode is executed (S9).

If it is decided that the number of battery packs 1 that needs charging is not two (S13: NO), it is decided whether the number of battery packs 1 that needs charging is one (S15). If it is decided that the number of battery packs 1 that needs charging is one (S15; YES), step S11 is executed and the charging-mode is set to the first charging-mode.

If it is decided that the number of battery packs 1 that needs charging is not one (S15: NO), the battery pack 1 is not in a state of being fixed to the holder 15 and thus the step goes back to S1 again.

3. Feature of Charging Device according to Present Embodiment

In the present embodiment, charging power for one or more battery packs 1 fixed to the holder 15 is controlled based on the battery information; thus, it is possible to suitably charge each secondary battery 2 while effectively using the maximum output power of the fuel cell 5. Thus, it can be possible to effectively charge a plurality of secondary batteries 2.

### Second Embodiment

1. Outline of Charging Device According to Present Embodiment

In the present embodiment, charging power for each battery pack 1 fixed to the holder 15 is controlled based on the allowable-charging-power information for each battery pack 1 obtained via each signal ports 15C and 15D, i.e. information about the necessary charging power for each battery pack 1. More specifically, the charging power for a battery pack 1 with a large amount of necessary charging power is made larger than the charging power for a battery pack 1 with a small amount of necessary charging power by the controlling unit 11.

2. Detail of Charge Control

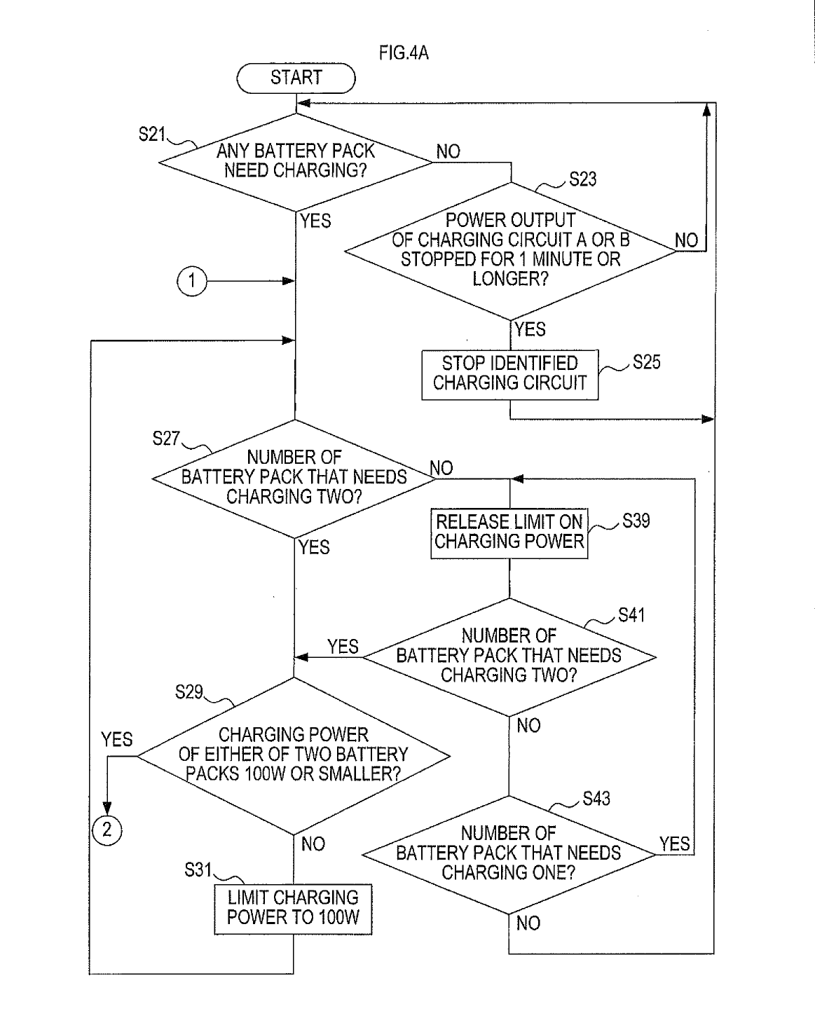

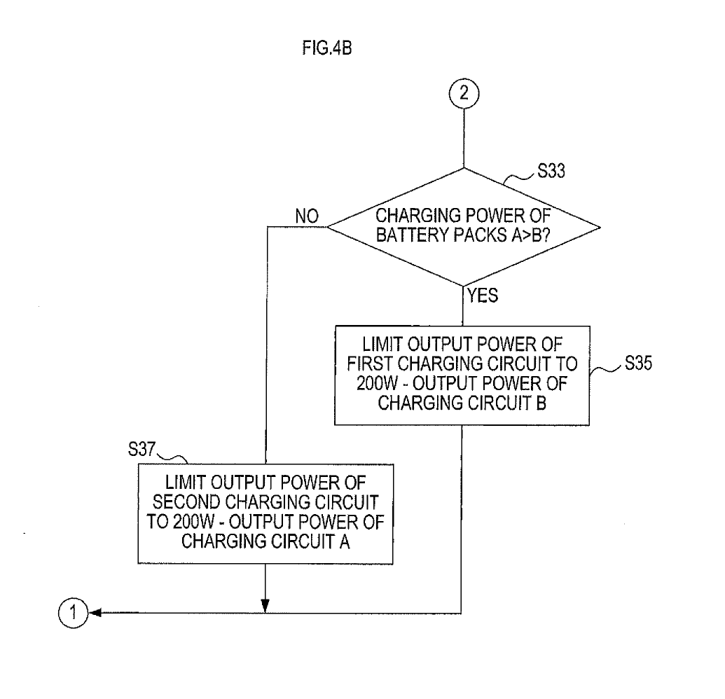

FIGS. 4A and 4B are flow charts indicating a charge control according to the present embodiment and are illustrating a case in which the maximum output power of the fuel cell 5 is 200 W and the necessary charging power for the battery pack 1 is 200 W or smaller as an example.

A program to execute a control flow illustrated in FIGS. 4A and 4B is stored in the above-mentioned non-volatile memory unit in advance and is read by the CPU 111 and activated when the activation switch of the charging device 10 is turned on. When the activation switch is turned off, execution of the program stops at that point.

If the program is activated, it is decided based on the battery information whether the battery pack 1 that needs charging is coupled to either the first charging-port 15A or the second charging-port 15B (S21). The battery pack 1 that needs charging includes an uncharged battery pack 1, that is, a brand-new battery pack 1.

If it is decided that the battery pack 1 that needs charging is not coupled to neither the first charging-port 15A nor the second charging-port 15B (S21: NO), it is decided whether either the first charging circuit 17A or the second charging circuit 17B is continuously in the state of outputting no charging power for a given time (for example, one minute) or longer (S23).

If it is decided that either the first charging circuit 17A or the second charging circuit 17B is continuously in thmore e state of outputting no charging power for the given time or longer (S23: YES), step S21 is executed after the identified charging circuit is put into a stopped state (S25). If it is decided that the state of outputting no charging power has not continued for the given time or longer (S23: NO), step S21 is executed without stopping the charging circuits.

If it is decided that the battery pack 1 that needs charging is coupled to either the first charging-port 15A or the second charging-port 15B (S21: YES), it is decided whether the number of battery packs 1 that needs charging is two (S27).

If it is decided that the number of battery packs 1 that needs charging is two (S27: YES), it is decided whether the necessary charging power for either of two battery packs 1 fixed to the holder 15 is equal to or smaller than the given first electric power (S29).

The first electric power is a value obtained by dividing the maximum output power of the fuel cell 5 by the number of the battery packs 1 fixed to the holder 15. Thus, the given electric power according to the present embodiment is a value obtained by dividing 200 W by 2, that is, 100 W.

If it is decided that the necessary charging power for any one of a plurality of (two) battery packs 1 fixed to the holder 15 is not equal to or smaller than the first electric power, in other words, the necessary charging power for any one of the battery packs 1 is larger than the first electric power (S29: NO), the second charging-mode is executed (S31), in which each battery pack 1 is charged in a state where the charging power is limited to the first electric power (100 W).

If it is decided that the necessary charging power for either of two battery packs 1 fixed to the holder 15 is equal to or smaller than the first electric power (S29: YES), it is decided whether the necessary charging power for the battery pack 1 fixed to the first charging-port 15A (hereinafter referred to as battery pack A) is larger than the necessary charging power for the battery pack 1 fixed to the second charging-port 15B (hereinafter referred to as battery pack B) (S33).

If it is decided that the necessary charging power for the battery pack A is larger than the necessary charging power for the battery pack 13 (S33: YES), the third charging-mode is executed (S35) wherein; (a) the necessary charging power for the battery pack B is set to charging power outputted from the second charging circuit 17B (the second charging-port 15B); and, (b) charging power outputted from the first charging circuit 17A (the first charging-port 15A) is “a value obtained by deducting the charging power outputted from the second charging circuit 17B from the maximum output power”.

If it is decided that the necessary charging power for the battery pack A is not larger than the necessary charging power for the battery pack B, in other words, the necessary charging power for the battery pack A is equal to or smaller than the necessary charging power for the battery pack B (S33: NO), the fourth charging-mode is executed (S37), wherein; (c) the necessary charging power for the battery pack A is set to charging power outputted from the first charging circuit 17A (the first charging-port 15A); and, (d) charging power outputted from the second charging circuit 17B (the second charging-port 15B) is “a value obtained by deducting the charging power outputted from the first charging circuit 17A from the maximum output power”.

If it is decided that the number of battery packs 1 that needs charging is not two, in other words, the number of battery packs 1 that needs charging is one (S27: NO), the charging-mode is switched to the first charging-mode (S39) as the second charging-mode that limits the charging power of each charging-port 15A and 1 5B to the above first electric power is deactivated.

If the second charging-mode is deactivated (S39), it is decided whether the number of battery packs 1 that needs charging is two (S41). If it is decided that the number of battery packs 1 that needs charging is two (S41: YES), the second charging-mode is executed (S31).

If it is decided that the number of battery packs 1 that needs charging is not two (S41: NO), it is decided whether the number of battery packs 1 that needs charging is one (S43). If it is decided that the number of battery packs 1 that needs charging is one (S43: YES), the step S39 is executed and the charging-mode is set to the first charging-mode.

If it is decided that the number of battery packs 1 that needs charging is not one (S43: NO), the battery pack 1 is not in a state of being fixed to the holder 15, and thus the step goes back to S21 again.

3. Feature of Charging Device According to Present Embodiment

In the present embodiment, charging power for one or more battery packs 1 fixed to the holder 15 is controlled based on the necessary charging power for each battery pack 1; thus, it is possible to suitably charge each secondary battery 2 while effectively using the maximum output power of the fuel cell 5. Thus, it can be possible to effectively charge a plurality of secondary batteries 2.

### Third Embodiment

1. Outline of Charging Device According to Present Embodiment

In the present embodiment, a battery pack 1 to charge is selected and charged among a plurality of battery packs 1 fixed to the holder 15 based on battery information, and also the battery packs 1 fixed to the holder 15 are charged in order from a battery pack 1 that is fixed to the holder 15 the earliest.

2. Detail of Charge Control

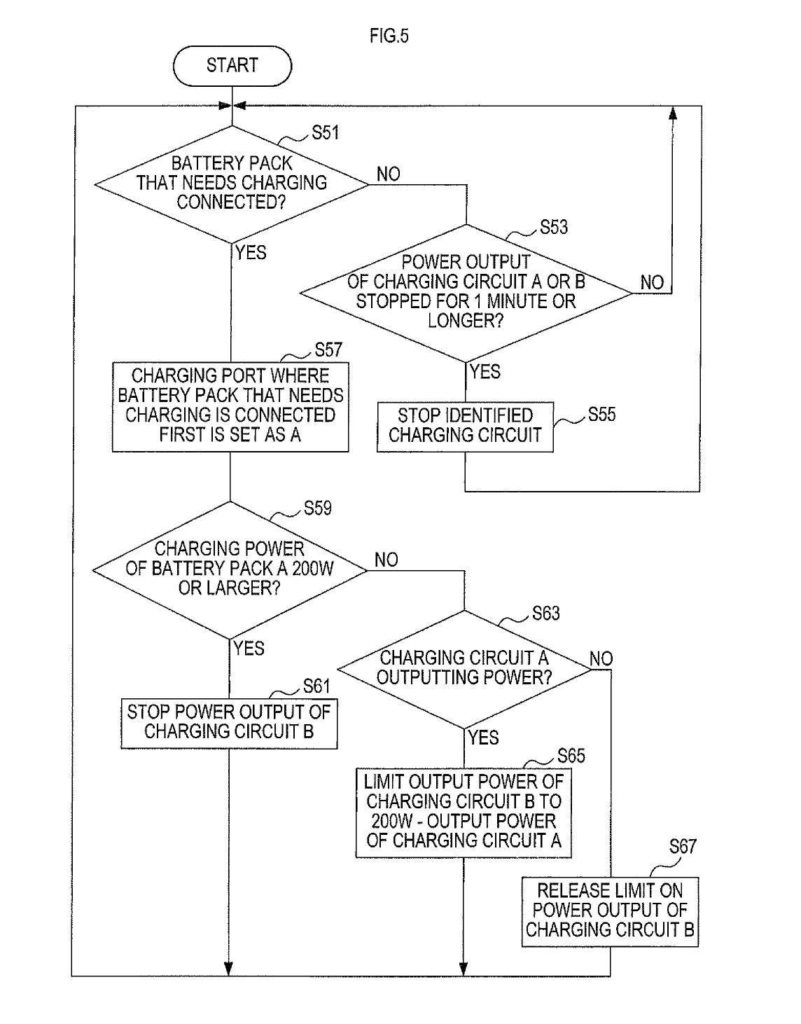

FIG. 5 is a flow chart indicating a charge control according to the present embodiment and is illustrating a case in which the maximum output power of the fuel cell 5 is 200 W and the necessary charging power for the battery pack 1 is 200 W or smaller as an example.

A program to execute the flow illustrated in FIG. 5 is stored in the above-mentioned non-volatile memory unit in advance and is read by the CPU 111 and activated when the activation switch of the charging device 10 is turned on. When the activation switch is turned off, execution of the program stops at that point.

If the program is activated, it is decided whether a battery pack 1 that needs charging is coupled to either the first charging-port 15A or the second charging-port 15B based on the battery information (S51). The battery pack 1 that needs charging includes an uncharged battery pack 1, that is, a brand-new battery pack 1.

If it is decided that the battery pack 1 that needs charging is not coupled to neither the first charging-port 15A nor the second charging-port 15B (S51: NO), it is decided whether the charging circuit of either the first charging circuit 17A or the second charging circuit 17B is continuously in the state of outputting no charging power for a given time (for example, one minute) or longer (S53).

If it is decided that either the first charging circuit 17A or the second charging circuit 17B is continuously in the state of outputting no charging power for the given time or longer (S53: YES), step S51 is executed after the identified charging circuit is put into a stopped state (S55). If it is decided that the state of outputting no power has not continued for the given time or longer (S53: NO), step S51 is executed without stopping the charging circuit.

If it is decided that the battery pack 1 that needs charging is coupled to either the first charging-port 15A or the second charging-port 15B (S51: YES), a charging-port setup is executed (S57).

More specifically, in step S57, a charging-port A is set to one of the charging-ports to which the battery pack 1 is fixed the earliest, and a charging-port B is set to the other charging-port. Among the first charging circuit 17A and the second charging circuit 17B, the charging circuit that corresponds to the charging-port A is hereinafter referred to as a charging circuit A, and the charging circuit that corresponds to charging-port B is hereinafter referred to as a charging circuit B.

After step S57 is executed, it is decided whether electric power that corresponds to the necessary-charging-power information obtained from the battery pack 1 fixed to the charging-port A (hereinafter referred to as battery pack A) is equal to or larger than the maximum output power (200 W) (S59). The battery pack 1 fixed to the charging-port B is hereinafter referred to as the battery pack B.

If it is decided that the necessary charging power for the battery pack A is equal to or larger than the maximum output power (200 W) (S59: YES), the controlling unit 11 limits the output power of the charging circuit B to zero, sets the output power of the charging circuit A to the maximum output power (200 W) and executes charging of the battery pack A (S61).

If it is decided that the necessary charging power for the battery pack A is not equal to or larger than the maximum output power (200 W) (S59: NO), it is decided whether the charging circuit A is outputting power, in other words, whether the charging to the battery pack A is executed (S63).

If it is decided that the charging circuit A is outputting power (S63: YES), the output power of the charging circuit B is set to “a value obtained by deducting the necessary charging power that the battery pack A demands from the maximum output power (200 W) (hereinafter refered to as set power output B)” (S65). If the necessary charging power that the battery pack B demands is smaller than the set power output B, the output power of the charging circuit B is set to the necessary charging power that the battery pack B demands.

If it is decided that the charging circuit A is not outputting power, in other words, the charging to the battery pack A is finished (S63: NO), the limit to set the output power of the charging circuit B to zero is released, and charging to the battery pack B begins (S67).

At this point, the output power of the charging circuit B is set to the necessary charging power that the battery pack B demands. Thereby, a plurality of battery packs 1 fixed to the holder 15 will be charged in order from a battery pack 1 that is fixed to the holder 15 the earliest.

3. Feature of Charging Device According to Present Embodiment

In the present embodiment, the battery pack 1 to charge is selected and charged among a plurality of battery packs 1 fixed to the holder 15 based on the battery information, and also the battery packs 1 fixed to the holder 15 are charged in order from a battery pack 1 that is fixed to the holder 15 the earliest; thus, it can be possible to efficiently charge a plurality of secondary battery 2 while effectively using the maximum output power of the fuel cell 5.

### Fourth Embodiment

1. Outline of Charging Device According to Present Embodiment

In the above-mentioned embodiments, the necessary charging power is determined in the battery controlling unit of the battery pack 1, and the charging device 10 obtains information of the determined necessary charging power as the battery information.

On the other hand, the charging device 10 according to the present embodiment obtains (a) status information of the secondary battery 2 and (b) identifying information indicating types of the battery pack 1 (the secondary battery 2) as the battery information, and determines charging power for each battery pack 1 using the obtained battery information.

In other words, although the above-mentioned embodiments comprise the charging-modes to execute charging wherein the charging power is set to the necessary charging power based on the information obtained from the battery pack 1, the charging device 10 according to the present embodiment per se determines electric power corresponding to the necessary charging power by using the battery information such as the status information and comprises a charging-mode to execute charging wherein the charging power is set to the determined electric power.

2.1 Detail of Charge Control

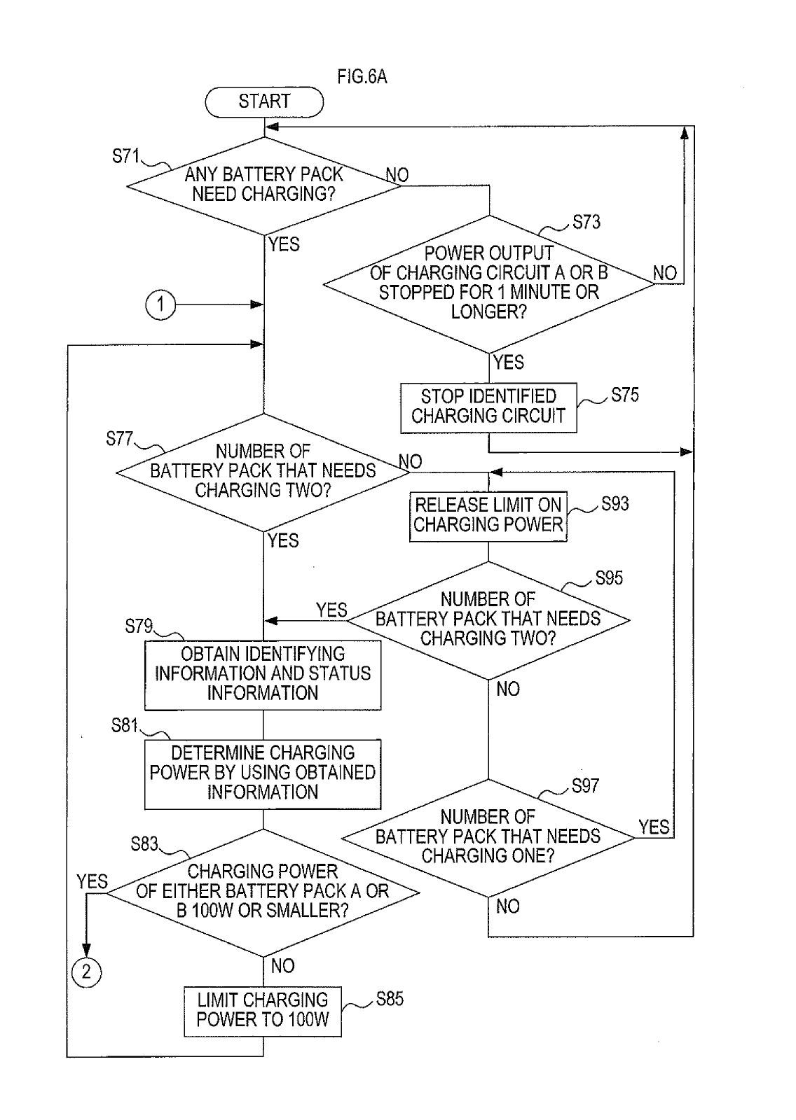

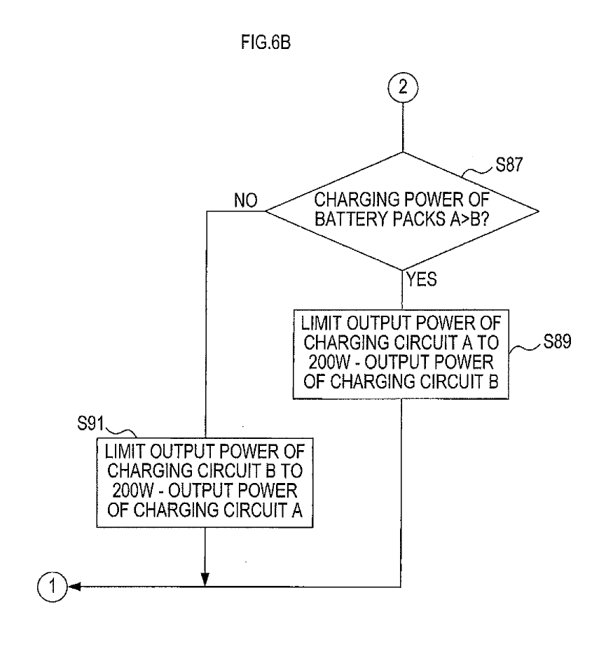

FIGS. 6A and 6B are flow charts indicating a charge control according to the present embodiment and are illustrating a case in which the maximum output power of the fuel cell 5 is 200 W and the maximum charging power at the time of charging the battery pack 1 is 200 W or smaller as an example.

A program to execute the flow illustrated in FIGS. 6A and 6B is stored in the above-mentioned non-volatile memory unit in advance and is read by the CPU 111 and activated when the activation switch of the charging device 10 is turned on. When the activation switch is turned off, execution of the program stops at that point.

If the program is activated, it is decided whether the battery pack 1 that needs charging is coupled to either the first charging-port 15A or the second charging-port 15B based on the battery information (S71). The battery pack 1 that needs charging includes an uncharged battery pack 1, that is, a brand-new battery pack 1.

If it is decided that the battery pack 1 that needs charging is not coupled to neither the first charging-port 15A nor the second charging-port 15B (S71: NO), it is decided whether either the first charging circuit 17A or the second charging circuit 17B is continuously in the state of outputting no charging power for a given time (for example, one minute) or longer (S73).

If it is decided that either the first charging circuit 17A or the second charging circuit 17B is continuously in the state of outputting no charging power for the given time or longer (S73: YES), step S71 is executed after the identified charging circuit is put into a stopped state (S75). If it is decided that the state of outputting no charging power has not continued for the given time or longer (S73: NO), step S71 is executed without stopping the charging circuit.

If it is decided that the battery pack 1 that needs charging is coupled to either the first charging-port 15A or the second charging-port 15B (S71: YES), it is decided whether the number of battery packs 1 that needs charging is two (S77).

If it is decided that the number of battery packs 1 that needs charging is two (S77: YES), identifying information and status information related to each battery pack 1 are obtained via each information output section 3 (S79), and then the charging power for each battery pack 1 is determined in the controlling unit 11 based on the obtained battery information (S81).

“A method for determining the charging power by using the obtained battery information” executed in the controlling unit 11, that is, details of step S81, will be mentioned later.

Next, it is decided whether the charging power of either of two battery packs 1 fixed to the holder 15 is equal to or smaller than the first electric power mentioned above (S83). If it is decided that the charging power of any one of a plurality of (two) battery packs 1 fixed to the holder 15 is not equal to or smaller than the first electric power (S83: NO), the second charging-mode is executed (S85), in which each battery pack 1 is charged in a state where the charging power is limited to the first electric power (100 W).

If it is decided that the charging power of either of two battery packs fixed to the holder 15 is equal to or smaller than the first electric power (S83: YES), it is decided whether the charging power of the battery pack 1 fixed to the first charging-port 15A (hereinafter referred to as battery pack A) is larger than the charging power of the battery pack 1 fixed to the second charging-port 15B (hereinafter referred to as battery pack B) (S87).

If it is decided that the charging power of the battery pack A is larger than the charging power of the battery pack B (S87: YES), the fifth charging-mode is executed (S89), wherein; (a) charging power for the battery pack B is set to the output power of the second charging circuit 17B (the second charging-port 15B); and, (b) the output power of the first charging circuit 17A (the first charging-port 15A) is “a value obtained by deducting the output power of the second charging circuit 17B from the maximum output power”.

If it is decided that the charging power of the battery pack A is not larger than the charging power of the battery pack B, (S87: NO), the sixth charging-mode is executed (S91), wherein; (c) charging power for the battery pack A is set to the output power of the first charging circuit 17A (the first charging-port 15A); and, (d) the output power of the second charging circuit 17B (the second charging-port 15B) is “a value obtained by deducting the output power of the first charging circuit 17A from the maximum output power”.

If it is decided that the number of battery packs 1 that needs charging is not two, in other words, the number of battery packs 1 that needs charging is one (S77: NO), the charging-mode is switched to the first charging-mode (S93) as the second charging-mode that limits the charging power of each charging-port 15A and 15B to the above first electric power or smaller is deactivated.

If the second charging-mode is deactivated (S93), it is decided whether the number of battery packs 1 that needs charging is two (S95). If it is decided that the number of battery packs 1 that needs charging is two (S95: YES), step S79 is executed.

If it is decided that the number of battery packs 1 that needs charging is not two (S95: NO), it is decided whether the number of battery packs 1 that needs charging is one (S97). If it is decided that the number of battery packs 1 that needs charging is one (S97: YES), step S93 is executed and the charging-mode is set to the first charging-mode.

If it is decided that the number of battery packs 1 that needs charging is not one (S97: NO), the battery pack 1 is not in a state of being fixed to the holder 15 and thus the step goes back to S71 again.

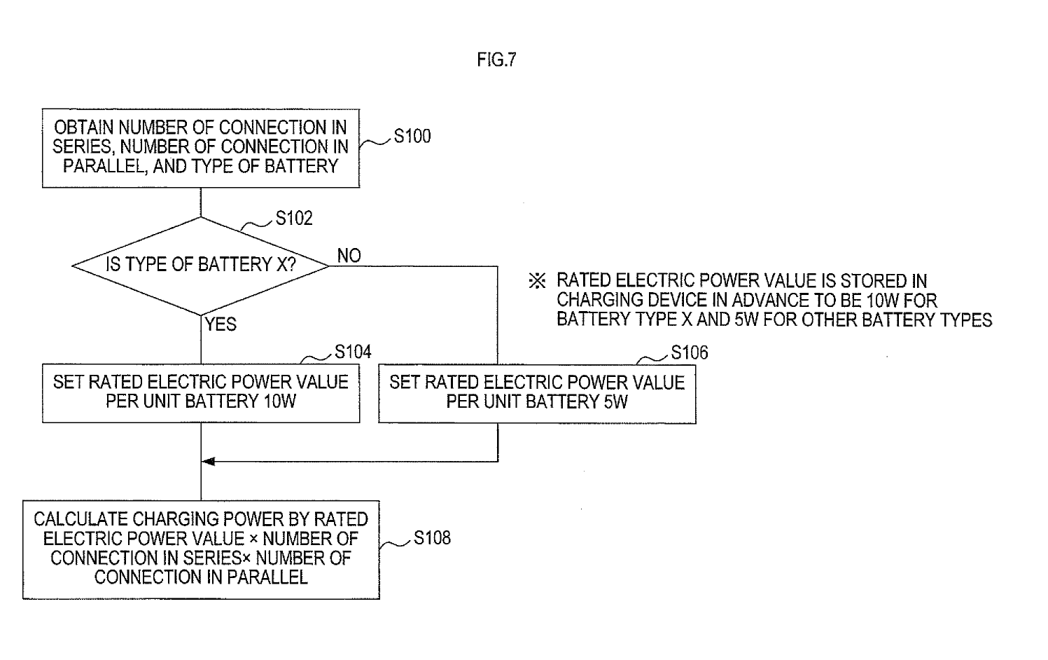

2.2 Method for Determining Charging Power Using Obtained Battery Information

<Determination of Charging Power Using Identifying Information (see FIG. 7)>

The secondary battery 2 of the battery pack 1 according to the present embodiment is configured with a plurality of battery cells (hereinafter also referred to as unit battery) connected in series and in parallel.

Thus, the identifying information, i.e., the type of the secondary battery 2 is defined by the number of unit batteries connected in series (hereinafter referred to as serial unit), the number of serial units connected in parallel, and output power of the unit battery. The charging device 10 according to the present embodiment can be used for a battery pack 1 with output power of 5 W and for a battery pack 1 with output power of 10 W.

When controlling determination of the charging power by using the identifying information, the number of unit batteries connected in series, the number of serial units connected in parallel, and output power value of the unit battery are obtained as the identifying information (S100), and then, it is decided whether the output power value is 10 W (S102) as illustrated in FIG. 7.

If it is decided that the output power value is 10 W (S102: YES), a variant 10 is inputted to indicate a rated electric power value (S104). If it is decided that the output power value is not 10 W (S102: NO), a variant 5 is inputted to indicate the rated electric power value (S106).

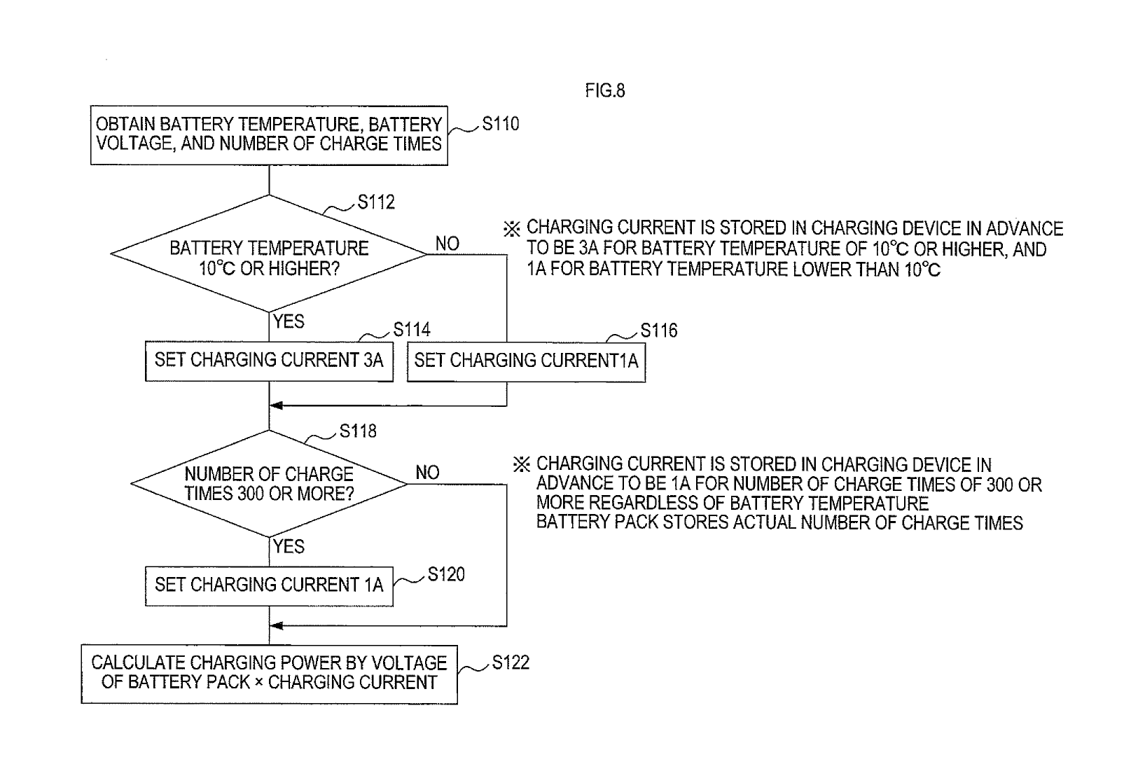

Then, the charging power is set to a value obtained by multiplying the number of unit batteries connected in series, the number of serial units connected in parallel, and the rated output power value (S108).

<Determination of Charging Power Using Status Information (see FIG. 8)>

It is decided whether temperature of the secondary battery 2 is equal to or higher than the first prescribed temperature (for example, 10° C.) (S112) after the temperature of the secondary battery 2, voltage of the secondary battery 2, and the total number of charge times are obtained as the status information (S110).

If it is decided that the temperature of the secondary battery 2 is equal to or higher than the first prescribed temperature (for example, 10° C.) (S112: YES), charging current is set to the first current value (for example, 3A) (S114). If it is decided that the temperature of the secondary battery 2 is lower than the first prescribed temperature (S112: NO), the charging current is set to the second current value (for example, 1A) that is smaller than the first current value (S116).

Next, it is decided whether the total number of charge times is equal to or more than the given number of times (for example, 300 times) (S118). If it is decided that the total number of charge times is equal to or more than the above given number of times (S118: YES), the charging current is set to the third current value (for example, 1A) that is smaller than the first current value (S120).

If it is decided that the total number of charge times is less than the above given number of times (S118: NO), the charging current set at step S114 or step S116 is maintained. Then, the charging power is set to a value obtained by multiplying voltage of the secondary battery 2 by the charging current (S122).

3. Feature of Charging Device According to Present Embodiment

In the present embodiment, since the charging power for one more more battery packs 1 fixed to the holder 15 is controlled based on the status information and the identifying information for each battery pack 1, it is possible to suitably charge each secondary battery 2 while effectively using the maximum output power of the fuel cell 5. Thus, it can be possible to effectively charge a plurality of secondary batteries 2.

### Fifth Embodiment

1. Outline of Charging Device According to Present Embodiment

The present embodiment is a variation of the Fourth Embodiment. In other words, the charging device 10 according to the present embodiment per se determines electric power that corresponds to the necessary charging power by using the battery information such as the status information, comprises a charging-mode to select a battery pack 1 to charge the determined electric power based on the charging power, and executes charging.

2. Detail of Charge Control

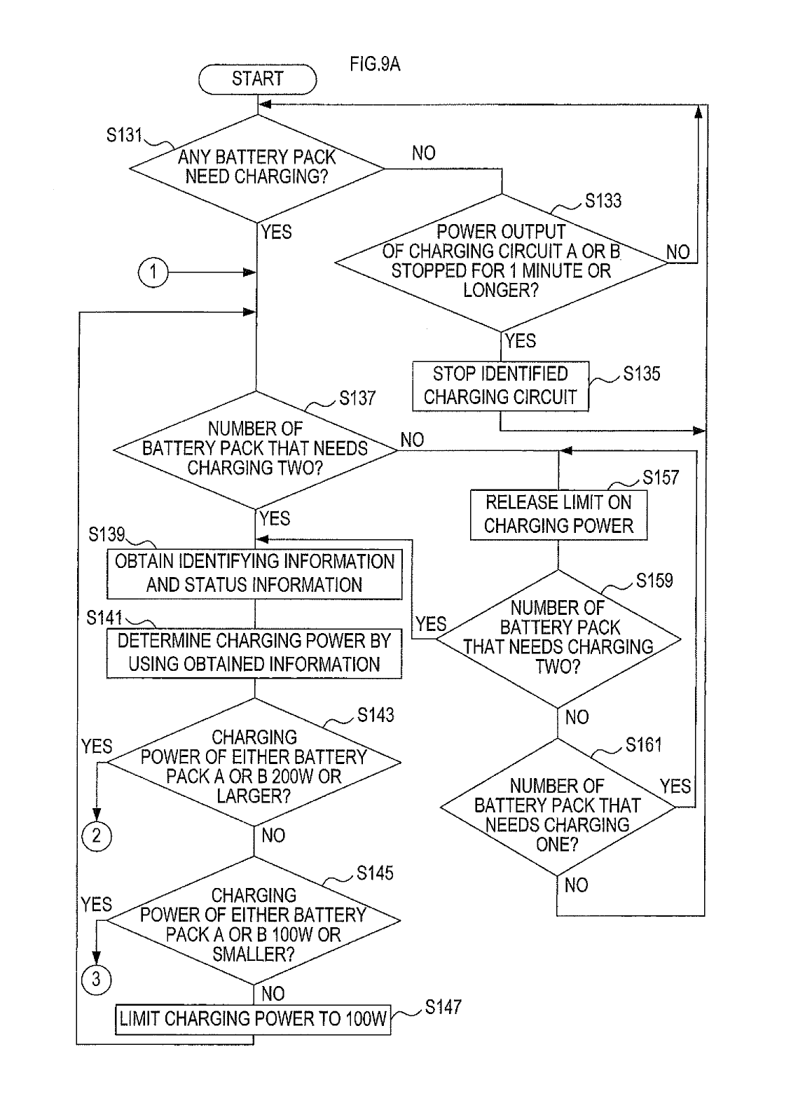

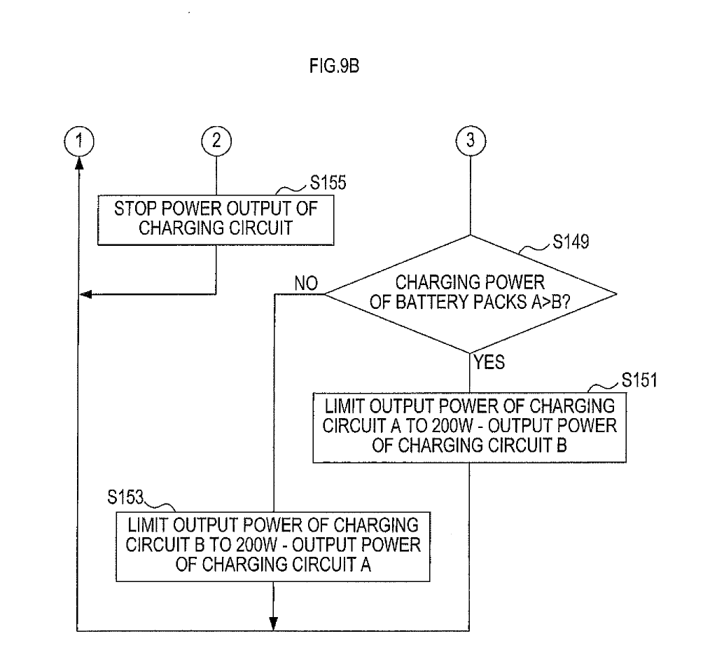

FIGS. 9A and 9B are flow charts indicating a charge control according to the present embodiment and are illustrating a case in which the maximum output power of the fuel cell 5 is 200 W and the maximum charging power when charging the battery pack 1 is 200 W or smaller as an example.

A program to execute the flow illustrated in FIGS. 9A and 9B is stored in the above-mentioned non-volatile memory unit in advance and is read by the CPU 111 and activated when the activation switch of the charging device 10 is turned on. When the activation switch is turned off, execution of the program stops at that point.

If the program is activated, it is decided whether the battery pack 1 that needs charging is coupled to either the first charging-port 15A or the second charging-port 15B based on the battery information (S131). The battery pack 1 that needs charging includes an uncharged battery pack 1, that is, a brand-new battery pack 1.

If it is decided that the battery pack 1 that needs charging is not coupled to neither the first charging-port 15A nor the second charging-port 15B (S131: NO), it is decided whether either the first charging circuit 17A or the second charging circuit 17B is continuously in the state of outputting no charging power for a given time (for example, 1 minute) or longer (S133).

If it is decided that either the first charging circuit 17A or the second charging circuit 17B is continuously in the state of outputting no charging power for the given time or longer (S133: YES), step S131 is executed after the identified charging circuit is put into a stopped state (S135). If it is decided that the state of outputting no charging power has not continued for the given time or longer (S133: NO), step S131 is executed without stopping the charging circuit.

If it is decided that the battery pack 1 that needs charging is coupled to either the first charging-port 15A or the second charging-port 15B (S131: YES), it is decided whether the number of battery packs 1 that needs charging is two (S137).

If it is decided that the number of battery packs 1 that needs charging is two (S137: YES), identifying information and status information for each battery pack 1 is obtained via each information output section 3 (S139), and then, the charging power for each battery pack 1 is determined based on the obtained battery information (S141).

“A method for determining charging power using the obtained battery information” executed in the controlling unit 11 is the same as that in the Fourth Embodiment.

It is decided whether the charging power of either one of two battery packs 1 fixed to the holder 15 is equal to or more than the maximum output power (200 W) (S143), If it is decided that the charging power of both of the battery packs 1 are smaller than the maximum output power (S143: NO), it is decided whether the charging power of either of two battery packs 1 fixed to the holder 15 is equal to or less than the first electric power (100 W) mentioned above (S145).

If it is decided that the charging power of any one of a plurality of (two) battery packs 1 fixed to the holder 15 is not equal to or less than the first electric power (S145: NO), the second charging-mode is executed, in which each batter pack 1 is charged in a state where the charging power is limited to the first electric power (100 W) (S147).

If it is decided that the charging power of either of two battery packs 1 fixed to the holder 15 is equal to or smaller than the first electric power (S145; YES), it is decided whether the charging power of the battery pack 1 fixed to the first charging-port 15A (hereinafter referred to as battery pack A) is larger than the charging power of the battery pack 1 fixed to the second charging-port 15B (hereinafter referred to as battery pack B) (S149).

If it is decided that the charging power of the battery pack A is larger than the charging power of the battery pack B (S149: YES), the fifth charging-mode is executed (S151), wherein; (a) charging power for the battery pack B is set to the output power of the second charging circuit 17B (the second charging-port 15B); and, (b) the output power of the first charging circuit 17A (the first charging-port 15A) is “a value obtained by deducting the output power of the second charging circuit 17B from the maximum output power”.

If it is decided that the charging power of the battery pack A is not larger than the charging power of the battery pack B (S 149: NO), the sixth charging-mode is executed (S153), wherein; (c) charging power of the battery pack A is set to the output power of the first charging circuit 17A (the first charging-port 15A); and, (d) the output power of the second charging circuit 1713 (the second charging-port 15B) is “a value obtained by deducting the output power of the first charging circuit 17A from the maximum output power”.

If it is decided at step S143 that the charging power of either of two battery packs 1 fixed to the holder 15 is equal to or larger than the maximum output power (200 W) (S143; YES), the power output of the charging circuit (the first charging circuit 17A or the second charging circuit 17B), to which the battery pack 1 that is decided to have the charging power of smaller than 200 W, is stopped (S155).

In other words, at step S155, the battery pack 1 that is decided to have the charging power of 200 W or larger is selected, and charging to the selected battery pack 1 is executed at the maximum output power. If the charging power of both of the battery packs 1 is equal to or larger than the maximum output power (200 W), the battery pack 1 that is fixed to the holder 15 the earliest is selected, and step S155 is executed thereto.

If it is decided that the number of battery packs 1 that needs charging is not two, i.e., the number of battery packs 1 that needs charging is one (S137: NO), the charging-mode is switched to the first charging-mode (S157) as the second charging-mode, in which the charging power of each charging-port 15A and 15B is limited to the above-mentioned first electric power or smaller, or the output stop (S155) of the charging circuit is deactivated.

If the second charging-mode is deactivated (S157), it is decided whether the number of battery packs 1 that needs charging is two (S159). If it is decided that the number of battery packs 1 that needs charging is two (S159: YES), step S139 is executed.

If it is decided that the number of battery packs 1 that needs charging is not two (S159: NO), it is decided whether the number of battery packs 1 that needs charging is one (S161). If it is decided that the number of battery packs 1 that needs charging is one (S161: YES), step S157 is executed and the charging-mode is set to the first charging-mode. Thereby, charging to the battery pack 1 coupled to the charging circuit, power output of which was stopped at step S155, begins.

If it is decided that the number of battery packs 1 that needs charging is not one (S161: NO), the battery pack 1 is not in a state of being fixed to the holder 15 and thus the step goes back to S131 again.

3. Feature of Charging Device According to Present Embodiment

In the present embodiment, the charging device 10 according to the present embodiment per se determines electric power corresponding to the necessary charging power by using the battery information such as the status information, selects the battery pack 1 to charge the determined electric power based on the charging power, and executes charging; thus, it is possible to suitably charge each secondary battery 2 while effectively using the maximum output power of the fuel cell 5. Thus, it can be possible to efficiently charge a plurality of secondary batteries 2.

### Other Embodiments

Although the detachable fuel cartridge 4 is filled with fuel in the above-mentioned embodiments, the present invention is not limited thereto; for example, the present invention may also be applied to a stationary power supply device that supplies fuel through piping.

Although the fuel cell 5 according to the above-mentioned embodiments is a direct methanol fuel cell, the present invention is not limited thereto; a fuel cell may also be of other types.

Although the secondary battery 9 according to the above-mentioned embodiments is a lithium-ion battery, the present invention is not limited thereto; other secondary batteries or capacitors and such may also be used.

Although a battery pack 1 that is fixed to the holder 15 the earliest is selected and charged among a plurality of battery packs 1 fixed to the holder 15 in the Third Embodiment, the present invention is not limited thereto.

For example, among a plurality of battery packs 1 fixed to the holder 15, a battery pack having the largest necessary charging power may be selected and charged, and the battery packs may be charged in order from this selected battery pack. In other words, a battery pack to be charged first may be selected based on battery information, and battery packs may be charged in order from the selected battery pack.

Although the controlling unit is configured with a microcomputer comprising the CPU in the above-mentioned embodiments, the controlling unit may also be configured with individual electronic circuits and ASIC.

The present invention is not limited to the above-mentioned embodiments as long as it is consistent with the intent of the invention described in the claims. Thus, the present invention may be a combination of at least two of the above-mentioned embodiments.

What is claimed is:

1. A charging device for a battery pack for a power tool, the device comprising;
a holder comprising a plurality of charging-ports where the battery pack for a power tool can be detachably fixed, wherein a secondary battery that can be charged and discharged and an information output section that can output information related to the secondary battery are integrated in the battery pack;
a fuel cell configured to generate electric power by oxidation reaction of fuel and an oxidant;
an information obtaining section configured to obtain information related to the battery pack fixed to the holder from the information output section; and,
a controlling unit configured to control charging power for one or more battery packs fixed to the holder based on information obtained in the information obtaining section.

2. A charging device for a battery pack for a power tool, the device comprising;
a holder comprising a plurality of charging-ports where the battery pack can be detachably fixed, wherein a secondary battery that can be charged and discharged and an information output section that can output information related to electric power for charging the secondary battery are integrated in the battery pack, the electric power for charging the secondary battery is referred to as allowable charging power;
a fuel cell configured to generate electric power by oxidation reaction of fuel and an oxidant;
an information obtaining section configured to obtain allowable charging power for the battery pack fixed to the holder from the information output section; and,
a controlling unit configured to control charging power for one or more battery packs fixed to the holder based on allowable charging power obtained in the information obtaining section and electric power that the fuel cell can output.

3. The charging device for a battery pack for a power tool according to claim 2, wherein the controlling unit comprises a charging-mode, in which each battery pack is charged at a value obtained by dividing electric power that can be outputted from the fuel cell by the number of the battery packs fixed to the holder.

4. A charging device for a battery pack for a power tool, the device comprising;
a holder comprising a plurality of charging-ports where the battery pack can be detachably fixed, wherein a secondary battery that can be charged and discharged and an information output section that can output information related to electric power for charging the secondary battery are integrated in the battery pack, the electric power for charging the secondary battery is referred to as allowable charging power;
a fuel cell configured to generate electric power by oxidation reaction of fuel and an oxidant;
an information obtaining section configured to obtain allowable charging power for the battery pack fixed to the holder from the information output section; and,
a controlling unit configured to control charging power for each battery pack fixed to the holder based on allowable charging power for each battery pack obtained in the information obtaining section.

5. The charging device for a battery pack for a power tool according to claim 4, wherein the controlling unit configured to make charging power for a battery pack with large allowable charging power larger than charging power for a battery pack with small allowable charging power.

6. A charging device for a battery pack for a power tool, the device comprising;
a holder comprising a plurality of charging-ports where the battery pack can be detachably fixed, wherein a secondary battery that can be charged and discharged and an information output section that can output information to identify types of the secondary battery are integrated in the battery pack, the information to identify types of the secondary battery is referred to as identifying information;
a fuel cell configured to generate electric power by oxidation reaction of fuel and an oxidant;
an information obtaining section configured to obtain identifying information of the battery pack fixed to the holder from the information output section; and,
a controlling unit configured to control charging power for each battery pack fixed to the holder based on identifying information of each battery pack obtained in the information obtaining section.

7. A charging device for a battery pack for a power tool, the device comprising;
a holder comprising a plurality of charging-ports where the battery pack can be detachably fixed, wherein a secondary battery that can be charged and discharged and an information output section that can output information to indicate status of the secondary battery are integrated in the battery pack, the information to indicate status of the secondary battery is referred to as status information;
a fuel cell configured to generate electric power by oxidation reaction of fuel and an oxidant;
an information obtaining section configured to obtain status information of the battery pack fixed to the holder from the information output section; and,
a controlling unit configured to control charging power for each battery pack fixed to the holder based on status information of each battery pack obtained in the information obtaining section.

8. The charging device for a battery pack for a power tool according to claim 7, wherein the status information comprises at least either information indicating temperature of the secondary battery or information indicating the number of charge times to the secondary battery.

9. A charging device for a battery pack for a power tool, the device comprising;
a holder comprising a plurality of charging-ports where the battery pack can be detachably fixed, wherein a secondary battery that can be charged and discharged and an information output section that can output information related to the secondary battery are integrated in the battery pack;
a fuel cell configured to generate electric power by oxidation reaction of fuel and an oxidant;
an information obtaining section configured to obtain information related to the battery pack fixed to the holder from the information output section; and,
a controlling unit configured to select and charge a battery pack to charge among a plurality of battery packs fixed to the holder based on information obtained in the information obtaining section.

10. The charging device for a battery pack for a power tool according to claim 9, wherein the controlling unit comprises a charging-mode, in which a plurality of selected battery packs is charged in order from a battery pack that is fixed to the holder the earliest.

11. A charging device for a battery pack for a power tool comprising a secondary battery that can be charged and discharged, the device comprising;
a holder that comprises a plurality of charging-ports where the battery pack can be detachably fixed;
a fuel cell configured to generate electric power by oxidation reaction of fuel and an oxidant; and,
a controlling unit configured to charge a plurality of battery packs fixed to the holder in order from a battery pack that is fixed to the holder the earliest.

12. A charging device for a battery pack for a power tool, the device comprising;
a holder comprising a plurality of charging-ports where the battery pack can be detachably fixed, wherein a secondary battery that can be charged and discharged and an information output section that can output information to identify types of the secondary battery are integrated in the battery pack, the information to identify types of the secondary battery is referred to as identifying information;
a fuel cell configured to generate electric power by oxidation reaction of fuel and an oxidant;
an information obtaining section configured to obtain identifying information of the battery pack fixed to the holder from the information output section; and,
a controlling unit configured to select and charge a battery pack to charge among a plurality of battery packs fixed to the holder based on identifying information of each battery pack obtained in the information obtaining section.

13. A charging device for a battery pack for a power tool, the device comprising;
a holder comprising a plurality of charging-ports where a battery pack can be detachably fixed, wherein a secondary battery that can be charged and discharged and an information output section that can output information to indicate status of the secondary battery are integrated in the battery pack, the information to indicate status of the secondary battery is referred to as status information;
a fuel cell configured to generate electric power by oxidation reaction of fuel and an oxidant;
an information obtaining section configured to obtain status information of the battery pack fixed to the holder from the information output section; and,
a controlling unit configured to select and charge a battery pack to charge among a plurality of battery packs fixed to the holder based on status information of each battery pack obtained in the information obtaining section.
